(19) United States
(12) Patent Application Publication
(10) Pub. No.: US 2006/0157614 A1
(43) Pub. Date: Jul. 20, 2006

(54) Wing for a compound helicopter

(76) Inventor: John Simpson, Shrivenham (GB)

Correspondence Address: JOHN S. PRATT, ESQ;KILPATRICK STOCKTON, LLP, 1100 PEACHTREE STREET, ATLANTA, GA, 30309, US

(21) Appl. No.: 10/542,816

(22) PCT Filed: Jan. 22, 2004
(86) PCT No.: PCT/GB04/00258

§ 371 Date: Dec. 15, 2005

(30) Foreign Application Priority Data
Jan. 22, 2003 (GB) 0301370.3

(51) Int. Cl. B64C 27/22

(52) U.S. Cl. 244/6

(57) ABSTRACT

A wing (11) for a compound helicopter having a lifting rotor comprises a plurality of wing elements (12) of which one wing element is rotatably mounted and in one position thereof the wing elements form a single continuous aerofoil. In a preferred embodiment the wing comprises a plurality of rotatably mounted wing elements. Each rotatable wing elements is rotated by rotating means so as to tend to reduce resistance to the downward airflow generated by the rotor when the helicopter is in vertical take off-landing mode.

The present invention is concerned with a wing for use in helicopters of the type employing wings to assist in forward flight. Such helicopters, herein termed “compound helicopters”, offer the potential of good cruise and forward flight control whilst preserving the vertical take off-landing (VTOL) characteristics of ordinary helicopters.

U.S. Pat. No. 5,738,301 describes a simple compound helicopter in which fixed aircraft-type wings are provided beneath the lifting rotor in order to provide additional lift and forward thrust and improve performance of the helicopter in forward flight. However, the arrangement suffers from the disadvantage that the fixed wings impede the downward thrust of air from the rotor and impairs performance of the helicopter in the hover (VTOL) mode. Further, the reduced downward thrust provided by the rotor has a significant impact on the weight and operational payload of the compound helicopter.

A number of approaches to the problem of impaired hover performance in compound helicopters are known. In particular, U.S. Pat. No. 4,928,907 discloses a compound helicopter, in which the wings are tilted to a vertical position during transition from forward flight to hover mode so as to reduce their impedance to airflow from the rotor on landing.

However, this approach has the disadvantage that in order to avoid interference with the lifting rotor the position of the wings beneath the rotor and/or the width of the wings is restricted. Consequently there may be a limitation on the benefit that the provision of wings beneath the lifting rotor can offer to the forward flight capabilities of the helicopter.

The present invention generally seeks to improve upon this situation by providing a wing which may be positioned beneath the lifting rotor so as to optimise the benefit to forward flight and which can be, at least in part, repositioned so to avoid resistance to downward airflow from the rotor.

Accordingly, in a main aspect, the present invention provides for a wing for a compound helicopter having a lifting rotor, comprising a plurality of wing elements of which at least one wing element is moveable to any position between a first position and a second position.

As used herein the term “wing element” refers to a portion of the main part of the wing. It will be apparent therefore that the term is not intended to refer to the whole of a wing, nor to ailerons, which may sometimes be present on wings provided for compound helicopters.

In one embodiment of the present invention, all of the wing elements are moveable. In another embodiment, only some of the wing elements comprising the wing are moveable. It will be understood that unless otherwise apparent, references in the following description to the moveable wing element include references to more tan one moveable wing element.

The present invention does not require that the wing elements are moveable in any particular sense or direction. In one embodiment of the present invention, the wing elements are moveable in a linear direction, which is substantially perpendicular to the fuselage of the helicopter, and are retractable within the fuselage of the helicopter.

However, in a preferred embodiment of the present invention, the moveable wing element is rotatable. In this embodiment the moveable wing element may be rotatable about a substantially horizontal or vertical axis of rotation. Preferably, however, the moveable wing element is rotatable about an horizontal axis which is substantially perpendicular to the fuselage of the helicopter. Alternatively, the horizontal axis may be substantially parallel to the fuselage of the helicopter. Still more preferably, the horizontal axis of rotation lies in or near to the waterline or equatorial plane of the helicopter.

It will be realised by those skilled in the art that when the moveable wing element occupies the first position the wing elements form a single, continuous aerofoil. However, when the moveable wing element is moved from the first position to any position up to, and including, the second position, the wing offers reduced resistance to the downward flow of air generated by the lifting rotor in the hover mode.

In the preferred embodiments, the moveable wing element may comprise a portion of the main part of the wing that provides a part of the leading edge and/or a part of the trailing edge thereof.

The present invention is not limited to any particular arrangement for mounting the moveable wing elements. It will be realised that a large number of mounting means are possible. Preferably, however, the moveable wing element is rotatably mounted.

In one embodiment of the present invention the mounting means comprise a wing element attached to the fuselage by a rotary bearing. It will be appreciated, however, that in this embodiment the loads acting on the wing element will be borne by a single bearing. Preferably, therefore, the mounting means comprise a supporting shaft extending at least in part on or within the wing element and a series of rotary bearings. In this embodiment the shaft is fixed to the fuselage of the helicopter and the wing element is rotatable about the shaft. In an alternative embodiment, however, the wing element is fixed to the shaft and the shaft is rotatable on the fuselage of the helicopter.

It will be understood that the present invention is not limited by any particular means for moving the moveable wing element. A large number of means will be known to those skilled in the art including linear and rotary electromechanical and hydraulic devices. In particular, the wing element may be mechanically or electrically linked to actuation means housed in the fuselage of the helicopter. It will also be realised that the displacement or rotation of several moveable wing elements may be coupled to each other and a single actuation means.

In some embodiments of the present invention the shaft may be positioned on or within the rotatable wing element so as to aid the rotation means. In particular, the shaft may extend substantially along the centre chord line of the wing element so as to balance the loads experienced by the front and back areas of the wing element in hover mode. Alternatively, the shaft may extend towards the front of the wing element so as to balance uplift resulting from forward motion of the helicopter with downward airflow from the main rotor.

The wing element of the present invention may comprise any material known to the art. Preferably, its surface is profiled so as to ensure that the wing elements mate together to form the single, continuous aerofoil when they are arranged in the first position. In addition the wing element may be further shaped or streamlined so as to tend to further reduce resistance to the downward airflow from the lifting rotor when they are arranged the second position.

The shaft used in some embodiments of the present invention is, in addition to supporting and distributing loads acting on the moveable wing element, also capable of supporting a pylon for carrying loads such as stores and fuel. In one embodiment the shaft extends beyond the longitudinal length of the wing element and provides simple means for the attachment of a wing tip pylon. The attachment of the wing tip pylon (or an end cap) linking several wing elements may also provide a certain rigidity and support to the wing. In other embodiments of the present invention pylons may be located at various positions along the longitudinal length of the wing. However, in these embodiments at least one slot or recess is provided in the wing element so as to allow for the free movement of the wing element without fouling the pylon. The slot, which receives a portion of the pylon as the wing element turns on the shaft, allows the pylon to remain in a fixed position relative to the fuselage when the wing element are rotated. The slot may also be provided with detachable plugging or blocking means acting to prevent leakage of airflow from the lower surface of the wing to the upper surface when the wing element is in the first position (forward flight).

In a further embodiment of the present invention the wing is provided with wing folding means. The wing folding means may provide that the wing can be folded to a position substantially parallel to and adjacent to the fuselage, which is advantageous when storing aircraft in confined spaces. Although various means for wing folding are possible, it will be apparent that for mechanical simplicity the wing fold will be inboard of the wing element.

In a second aspect, the present invention provides for a compound helicopter having a lifting rotor and horizontal wings on opposite sides thereof in which each wing comprises a plurality of wing elements of which at least one wing element is moveable to any position from a first position to a second position.

In one embodiment of the present invention the wing element is rotatable. It will be realised that the wing element in one wing may be independently rotatable to the wing element in the other wing whereby to provide means countering torque acting on the helicopter. Thus, the rotatable wing elements may be moved to dissimilar positions so as to introduce an asymmetric downward airflow from the lifting rotor.

It will be apparent to those skilled in the art that the wing of the present invention is suitable for use in a variety of compound helicopter configurations. In particular, the wing is suitable for use in configurations, which retain use of a tail rotor to control yaw or in configurations employing a ducted yaw control jet (NOTAR configurations). In these configurations a reduction in torque effects provided by asymmetric positioning of the rotatable wing elements may prove advantageous in certain situations such as recovery to a ship in a crosswind. The wing is also suitable for configurations, which provide forward thrust independently of the lifting rotor.

The wing of the present invention provides a number of advantages over the prior art. In particular, the fact that the wing comprises wing elements that are rotatably mounted avoids the need to rotate the whole wing so as to reduce the resistance to downward airflow when the helicopter is in hover mode. The present invention thereby provides the advantage of a reduced requirement for vertical space and allows the optimum placing of the wings in a compound helicopter for uplift and forward flight without obstruction by the lifting rotor or ground.

In addition the mounting means can provide for the attachment of load carrying pylons whereby the position of the load with respect to the fuselage is unchanged between the flight and the hover mode of the helicopter. The present invention therefore provides for a compound helicopter that can carry loads of greater length than the width of the wing and which are longer than those possible with a compound helicopter having a tilting wing. Further, there is no undue burden on either the wing, pylon or drive means for the rotatable wing elements when compared with wing to vertical tilting wing helicopters.

The present invention also offers a compound helicopter having wings that provide for asymmetric downward airflow when the helicopter is in the hover mode so providing the potential advantage that torque acting on the helicopter may be counteracted without the need for a tail rotor.

The present invention also provides the advantage that, because the wing elements can act as individual aerofoils during the transition of the helicopter between forward flight and hover, problems of vibration due to stalling are reduced when compared to fixed wing compound helicopters.

It will therefore be appreciated that the present invention provides a versatile compound helicopter which offers the performance enhancement in forward flight of a compound helicopter whilst minimising the penalty to thrust in hover mode caused by the presence of a wing under the lifting rotor. The helicopter of the present invention therefore offers increased payload capacity when compared with fixed wing compound helicopters.

The present invention will now be described with reference to several embodiments and the accompanying drawings in which

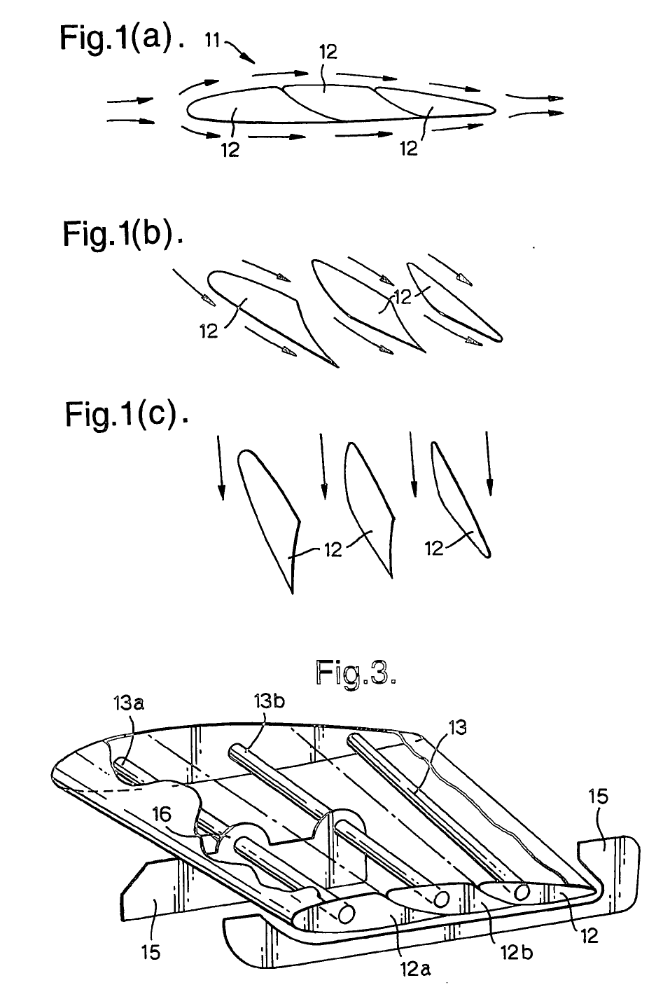

FIG. 1 a) to c) provide section views of one embodiment of the wing according to the present invention in which the transition of the wing elements form their first position to their second position is shown;

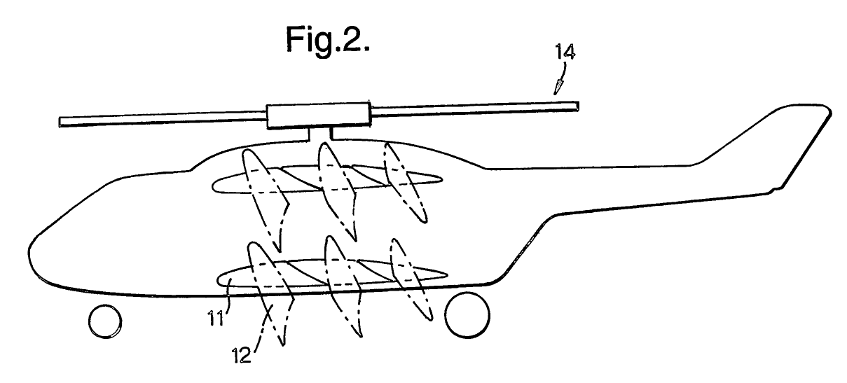

FIG. 2 is an side view of a compound helicopter according to the present invention showing two possible positions for the wing;

FIG. 3 is a perspective, part cut-away view of one embodiment of the wing according to the present invention showing spar elements supporting a pylon.

Having regard to FIGS. 1 to 3, a “louvred” wing, generally designated 11, comprises three wing elements 12 each having mounting means in the form of a shaft 13 extending along the length of the wing element. The shafts 13 each provide for rotation of a wing element about a horizontal axis that is substantially perpendicular to the length of the wing 11. The drive means in this embodiment comprise a motor (not shown) coupled to each shaft 13.

FIGS. 1 a) to c), in which the arrows indicate the direction of airflow, show the rotation of the wing elements 12 from a first position a) to a second position c). The rotation accompanies the transition of the helicopter from forward flight to hover mode.

As may be seen, in the first position a) the wing elements 12 mate together to form a single, continuous aerofoil 11 suitable for forward flight of the helicopter. In this configuration the relative wind experienced by the wing comprises the summation of airflow due to forward motion and the downward airflow of the lifting rotor. The wing comprising the wing elements 12 is arranged so that the mean camber line of the aerofoil 11 is at a slight positive angle to the relative wind in fast forward flight so that the wing provides a suitable uplift.

As the helicopter slows the relative wind experienced by the wing is increasingly dominated by the downward airflow of the lifting rotor and the lift on the wing becomes negative. During this transition phase the wing elements 12 are rotated so as to present a minimal surface area to the relative wind whereby to reduce the resistance to downward airflow from the rotor. In this configuration (FIG. 1(b)) the shape of the wing elements also provide for the minimum separation of airflow so as to reduce vibration of the helicopter (“stalling”). It will be appreciated that the vibration due to turbulent separation of airflow is at a maximum in a fixed wing compound helicopter during this transition phase.

By the time the helicopter reaches the hover mode the wing elements 12 are rotated through substantially 90° to a second position in which they are vertical and offer the minimum resistance to downward airflow from the rotor (FIG. 1(c)).

Referring now to FIG. 2, it will be realised that the position of the wing 11 in a compound helicopter, generally designated 14, can be varied between two extremes (shown) in which respectively the wing is situated above or below the cabin area of the helicopter. In these embodiments a carry through shaft 13 (not shown) is run through the body of the helicopter 14 so as to provide support to respective wing elements 12 in both wings 11 of the helicopter. The carry through shaft 13 may be a continuation of one or more of shafts 13 in the wing elements 12 or may form part of a separate structure to which the shafts are attached.

It will be apparent that the vertical space occupied by each wing element 12 in its second position (shown in broken lines) is much less than the space occupied if the whole wing 11 were rotated. Consequently the relative freedom in the positioning of the wing relative to the body or fuselage of the helicopter 14 is much greater than in compound helicopters in which the whole wing is rotated notwithstanding the need to avoid the carry through shaft 13 occupying cabin space.

Referring now to FIG. 3, a wing 11 comprising three wing elements 12, 12a, 12b shown in their first position in which they form a single continuous aerofoil. As previously mentioned, the wing elements are rotatably mounted on respective shafts 13, 13a, 13b extending along the length of each wing element 12, 12a, 12b. However, in this embodiment the spar elements are not driven but fixedly positioned to support the wing elements on the fuselage. Other drive means (not shown) are provided for the rotation of each wing element

Two of the shafts 13a, 13b also provide for the support of a pylon 15 which may be used for the attachment of loads such as fuel or the like. The pylon 15, which generally comprises a plate, has an upper portion having two arcuate protrusions 16 with apertures there through for receipt of respective shafts 13a, 13b. Of course, it will be realised that the lower portion of the under body of each wing element 12a, 12b is provided with a slot (not shown) allowing the protrusions 16 to extend therein and engage the shafts 13a 13b. In this embodiment the slot extends across the width and height of each wing element 12a, 12b so as to prevent the pylon 15 obstructing their rotation. It will be clear therefore that rotation of the wing elements 12a, 12b, does not lead to rotation of pylon 15 which remains fixed in position with respect to the body or fuselage of the helicopter.

1. A wing for a compound helicopter having a lifting rotor, comprising a plurality of wing elements of which at least one wing element is moveable to any position from a first position to a second position.

2. A wing according to claim 1, further comprising means for moving the at least one wing element.

3. A wing according to claim 1, which the at least one moveable wing element is rotatable.

4. A wing according to claim 3, in which at least one rotatable wing element is mounted on a driven shaft.

5. A wing according to claim 3, in which the at least one rotatable wing element is mounted on at least one driven rotary bearing.

6. A wing according to claim 5, in which the at least one rotatable wing element comprises a shaft for supporting a pylon or wing tip end piece.

7. A wing according to claim 6, in which the at least one rotatable wing element is provided with a slot for receipt of a portion of the pylon during their rotation.

8. (canceled)

9. A compound helicopter having a lifting rotor and horizontal wings on opposite sides of the fuselage in which each wing comprises a plurality of wing elements of which at least one wing element is moveable to any position from a first position to a second position.

10. A compound helicopter according to claim 9, in which the at least one wing element is rotatable.

11. A compound helicopter according to claim 10, in which the wing elements are independently rotatable from each other to counteract torque acting on the helicopter.

12. A compound helicopter according to claim 9, in which each wing is provided with a wing folding mechanism to fold each wing in a position substantially parallel to and adjacent to the fuselage.

13. A compound helicopter, comprising the wing of claim 1.

15. (canceled)
